(19) United States
(12) Patent Application Publication
(10) Pub. No.: US 2026/0326774 A1
(43) Pub. Date: Oct. 22, 2026

(54) METHOD FOR OPERATING A MOTOR VEHICLE AND MOTOR VEHICLE

(71) Applicant: Robert Bosch GmbH, Stuttgart (DE)

(72) Inventors: Christoph Diekmann, Besigheim (DE); David Volkmer, Marbach Am Neckar (DE); Heiko Walter, Untergruppenbach (DE); Marcel Bastian, Tamm (DE); Maximilian Bayer, Tamm (DE); Michael Hofmann, Mannheim (DE); Philipp Seibold, Fellbach (DE); Sebastian Stolz, Neckarwestheim (DE); Thorsten Maucher, Heidelberg (DE)

(21) Appl. No.: 19/105,839

(22) PCT Filed: Nov. 20, 2023
(86) PCT No.: PCT/EP2023/082405

§ 371 Date: Feb. 24, 2025

(30) Foreign Application Priority Data
Nov. 29, 2022 (DE) 10 2022 212 810.9

(51) Int. Cl. B60W 50/035; B60W 10/04; B60W 10/18; B60W 10/20; B60W 50/04

(52) U.S. Cl. CPC B60W 50/035; B60W 10/04; B60W 10/18; B60W 10/20; B60W 50/04; B60W 2520/10; B60W 2540/10; B60W 2540/12; B60W 2540/16; B60W 2540/18; B60W 2710/18; B60W 2710/20; B60W 2720/106

(57) ABSTRACT

A method for operating a motor vehicle. The motor vehicle includes at least one first actuating device which can be actuated by a driver for specifying a braking, acceleration and/or steering request, and at least one second actuating device which can be actuated by the driver for specifying a request in a normal operation that is independent of the braking, acceleration and/or steering request. The first actuating device is monitored for a malfunction. If a malfunction of the first actuating device is identified, the braking, acceleration and/or steering request is instead ascertained as a function of an actuation duration, actuation force and/or actuation mode of the second actuating device, and that a corresponding braking, acceleration and/or steering maneuver is carried out as a function of the ascertained braking, acceleration and/or steering request.

### FIELD

The present invention relates to a method for operating a motor vehicle, wherein the motor vehicle comprises at least one first actuating device which can be actuated by a driver for specifying a braking, acceleration and/or steering request, wherein the motor vehicle comprises at least one second actuating device which can be actuated by the driver for specifying a request in a normal operation that is independent of the braking, acceleration and/or steering request, and wherein the first actuating device is monitored for a malfunction.

The present invention also relates to a motor vehicle.

### BACKGROUND INFORMATION

Detecting an actuation of an actuating device for a motor vehicle which can be actuated by a driver by means of a sensor assigned to the actuating device is described in the related art. If the driver actuates the actuating device, in particular a braking or acceleration request of the driver is identified as a function of this. Conventionally, for instance, are brake systems with electromechanical brake boosters that, together with a vehicle assistance system, in particular an electronic stability program (ESP), form a redundant brake-by-wire system in which there is no mechanical connection from the actuating device to the brake system. A braking request is forwarded, for example as a function of an actuation of the actuating device, to an electromechanical actuator which is configured to build up pressure in the brake system.

Combinations of such actuating devices with actuating devices for specifying a request in a normal operation that is independent of the braking, acceleration and/or steering request are also described in the related art. German Patent Application No. DE 10 2019 009 040 A1, for example, describes a vehicle comprising a steering device with a left and a right handle, wherein an actuating element for braking or accelerating the vehicle and a paddle shifter, in particular for selecting a stage of an automatic transmission, are disposed on each of the handles.

Lastly, methods for identifying malfunctions of the actuating device and/or the sensor are described in the related art as well. German Patent Application No. DE 10 2018 113 865 A1, for example, describes a method for determining the state of a pedal actuation system in a vehicle, wherein a normal operating state or an error state of an actuating pedal is identified as a function of two sensor signals.

### SUMMARY

In a method according to the present invention, if a malfunction of the first actuating device is identified, the braking, acceleration and/or steering request is instead ascertained as a function of an actuation duration, actuation force and/or actuation mode of the second actuating device, and that a corresponding braking, acceleration and/or steering maneuver is carried out as a function of the ascertained braking, acceleration and/or steering request. This creates a particularly advantageous redundancy for detecting the braking, acceleration and/or steering request. The first actuating device is in particular assigned at least one first sensor for detecting an actuation, and the actuating device and/or the first sensor are monitored for a malfunction. The actuating device is particularly preferably assigned at least one second sensor for redundantly detecting the actuation, and sensor signals from the sensors are monitored for a malfunction, in particular by comparing them with one another. The redundant detection of the actuation of the actuating device has the advantage that reliable identification of a respective input of the driver is ensured at all times, even if one of the sensors fails. The actuation of the actuating device is preferably detected by means of one or two sensors disposed on the actuating device, for example angle sensors, displacement sensors, pressure sensors or force sensors, and the respective request is ascertained using the second actuating device instead in particular only when these sensors fail. The braking, acceleration and/or steering maneuver is preferably carried out with a specified strength or power; a specified braking power or brake pressure, a drive power or acceleration and/or a steering angle is in particular set. When the malfunction of the first actuating device is detected, the detection of the independent request by the second actuating device is particularly preferably suspended, so that the second actuating device is now used only to identify the braking, acceleration and/or steering request. When the malfunction is detected, a message is in particular output on a display device assigned to the driver, after which the second actuating device is used, exclusively or additionally, to identify the respective request. This advantageously increases safety for the driver.

According to a preferred further development of the present invention, it is provided that a steering device, a brake system and/or a drive unit of the motor vehicle are controlled as a function of the ascertained braking, acceleration or steering request. Such a configuration of the actuating device advantageously ensures that a steering request, acceleration request and/or deceleration request of a driver of the motor vehicle is reliably detected. The actuating device is preferably part of a steer-by-wire system, a brake-by-wire system and/or a drive-by-wire system; i.e. it has no mechanical connection to the steering device, brake system and/or drive unit. The first actuating device in particular comprises a pedal arrangement with at least one pedal, an actuating surface, a joystick and/or a steering handle. The actuating surface is preferably configured to output acceleration and/or deceleration requests to the brake system and/or the drive unit. In particular an actuation force of the actuating surface is ascertained for this purpose. The actuating surface is preferably at least largely stationary or without travel, i.e. not or at least only slightly displaceable. The actuation is in particular detected as a function of a displacement path and/or a spatial position of the actuating device. The steering handle is particularly preferably configured to output steering requests. In particular a rotation angle of the steering handle is acquired for this purpose. The pedal arrangement preferably comprises an accelerator pedal, a brake pedal or a combined accelerator pedal that is configured to output acceleration and deceleration requests to both the brake system and/or the drive unit. With such an output and control, the advantages of the method according to the present invention are particularly pronounced. The joystick is particularly preferably configured to output both acceleration requests and deceleration requests, and in particular alternatively or additionally steering requests. A signal is transmitted to a component of a brake system of the motor vehicle, for example a controllable actuator, according to the movement of the pedal or the joystick, in particular its movement speed or its angle of movement, and a corresponding brake pressure is built up by the actuator as described above.

According to an example embodiment of the present invention, it is particularly preferably provided that the second actuating device is configured such that at least two, in particular four, different actuation modes for a braking and an acceleration request and/or a steering request to the left and to the right can be detected or are detected. Such a configuration of the second actuating device results in the advantage that at least the failure of a brake pedal and an accelerator pedal or a steering handle as part of the first actuating device is fully compensated. Two different actuation modes enables reliable detection of at least two of the driver's requests (braking and accelerating, or steering to the left and steering to the right). Four different actuation modes actually enables reliable detection of all of the driver's requests (braking, accelerating, steering to the left, steering to the right).

According to a preferred further development of the present invention, it is provided that the second actuating device comprises two actuating elements, in particular paddle shifters or for setting a recuperation, which are disposed on a steering handle of the motor vehicle. With such actuating elements, the advantages of the method according to the present invention are particularly pronounced. The use of these actuating elements is advantageously intuitively understandable for the driver. Each of the actuating elements is used to detect a different request of the driver, for instance. The actuation mode and/or actuation duration when the request is instead specified by the driver preferably differs from the actuation mode and/or duration commonly used in normal operation.

According to an example embodiment of the present invention, it is particularly preferably provided that a braking or acceleration request is identified as the actuation mode when both actuating elements are actuated simultaneously. Such an actuation mode has the advantage that it deviates from an actuation mode commonly used in a normal operation, in which only one of the actuating elements is actuated, in particular for upshifting or downshifting or for increasing or reducing recuperation, and thus reliably prevents incorrect operation. When both actuating elements are actuated simultaneously, preferably when a specified actuation force is reached, in particular a full braking request is identified.

According to a preferred further development of the present invention, it is provided that, the actuating elements can both be displaced or pivoted in a first direction and in a second direction, in particular opposite to the first direction, and that when both actuating elements are actuated simultaneously in the first direction a braking request is identified as the actuation mode and when they are both moved in the second direction an acceleration request is identified as the actuation mode, or that when at least one of the actuating elements is actuated in the first direction an acceleration request is identified as the actuation mode and when at least one of the actuating elements is actuated in the second direction a braking request is identified as the actuation mode. Such an actuation mode advantageously ensures that both an acceleration request and a braking request are reliably identified. The actuating elements are disposed on the actuating device and in the motor vehicle in such a way that they are pivoted away from the driver (toward the front of the vehicle) in one of the directions, in particular in the first direction, and pivoted toward the driver (toward the rear of the vehicle) in the other of the directions, in particular in the second direction, for instance.

Alternatively, the actuating elements are disposed on the actuating device and in the motor vehicle in such a way that they are pivoted upward (toward the top of the vehicle) in one of the directions, in particular in the first direction, and pivoted downward (toward the bottom of the vehicle) in the other of the directions, in particular in the second direction. Both actuation modes are known from operating elements for speed control assistants (cruise control), for example, so that the driver can advantageously understand the operation intuitively. Alternatively, the actuating elements are disposed on the actuating device and in the motor vehicle in such a way that they are pivoted to the left (in the vehicle) in one of the directions, in particular in the first direction, and pivoted to the right (in the vehicle) in the other of the directions, in particular in the second direction. In each case, a strength of the respective braking, acceleration or steering maneuver is in particular defined as a function of a displacement path and/or a pivot angle. The further the actuating device is displaced or pivoted, the stronger the respective braking, acceleration or steering maneuver preferably is.

According to an example embodiment of the present invention, it is particularly preferably provided that the actuating elements are disposed on the steering handle as a left and a right actuating element, and that when only the left or only the right actuating element is actuated, a corresponding steering request in the respective direction is identified as the actuation mode or when only the left actuating element is actuated, a braking request is identified as the actuation mode and when only the right actuating element is actuated an acceleration request is identified as the actuation mode. Such an actuation mode advantageously ensures that both an acceleration request and a braking request or a steering request to the left or to the right are reliably identified. The assignment of the steering request advantageously corresponds to the spatial arrangement of the actuating elements on the steering handle (left and right). The assignment of the braking request and the acceleration request similarly advantageously corresponds to the spatial arrangement of the respective pedals and the actuating elements on the steering handle. These actuation modes are therefore advantageously intuitively understood by the driver.

According to a preferred further development of the present invention, it is provided that the second actuating device comprises an actuating lever, in particular an automatic selector lever or a gear selector lever, which can be displaced or pivoted at least in a first direction and in a second direction, in particular opposite to the first direction, and that a braking request is identified as the actuation mode when it is actuated in the first direction and an acceleration request is identified as the actuation mode when it is actuated in the second direction, or that, when it is actuated in the first direction, a steering request to the left is identified as the actuation mode, and, when it is actuated in the second direction, a steering request to the right is identified as the actuation mode. Such an actuation mode advantageously ensures that both an acceleration request and a braking request or a steering request to the left and to the right are reliably identified. The actuating lever is disposed on the actuating device and in the motor vehicle in such a way that it is pivoted or displaced away from the driver (toward the front of the vehicle) in one of the directions, in particular in the first direction, and pivoted or displaced toward the driver (toward the rear of the vehicle) in the other of the directions, in particular in the second direction, for instance. Alternatively, the actuating lever is disposed on the actuating device and in the motor vehicle in such a way that it is pivoted or displaced upward (toward the top of the vehicle) in one of the directions, in particular in the first direction, and pivoted or displaced downward (toward the bottom of the vehicle) in the other of the directions, in particular in the second direction. Both actuation modes are known from operating elements for speed control assistants (cruise control), for example, so that the driver can advantageously understand the operation intuitively. The actuating lever is therefore in particular also configured as a respective operating element for speed control assistants (cruise control). This last-mentioned actuation mode is known from joysticks, for example, so that this operation too is advantageously intuitively understood by the driver.

Alternatively, the actuating lever is disposed on the actuating device and in the motor vehicle in such a way that it is pivoted to the left (in the vehicle) in one of the directions, in particular in the first direction, and pivoted to the right (in the vehicle) in the other of the directions, in particular in the second direction. This actuation mode is known from joysticks, for example, so that this operation too is advantageously intuitively understood by the driver. In each case, a strength of the respective braking, acceleration or steering maneuver is in particular defined as a function of a displacement path and/or a pivot angle. The further the actuating device is displaced or pivoted, the stronger the respective braking, acceleration or steering maneuver preferably is.

According to an example embodiment of the present invention, it is particularly preferably provided that the actuating lever can be displaced or pivoted in at least four, in particular mutually orthogonal, directions, and that, when it is actuated in one of the four directions, either a braking request, an acceleration request, a steering request to the left or a steering request to the right are identified as the actuation mode, so that each of the directions is assigned its own request, wherein the directions for a braking and an acceleration request and for the steering request to the left and to the right are in particular respectively assigned opposite to one another. Such an actuation mode advantageously ensures that both an acceleration request and a braking request and a steering request to the left and to the right, i.e. all possible requests from the driver, are reliably identified. This actuation mode is known from joysticks, for example, so that this operation is advantageously intuitively understood by the driver. In each case, a strength of the respective braking, acceleration or steering maneuver is in particular defined as a function of a displacement path and/or a pivot angle. The further the actuating device is displaced or pivoted, the stronger the respective braking, acceleration or steering maneuver preferably is.

According to a preferred further development of the present invention, it is provided that the second actuating device comprises an actuating knob, in particular for actuating a parking brake, and that, when it is actuated a braking request or an acceleration request is identified as the actuation mode. Such an actuation mode creates a particularly advantageously simple alternative option for detecting the request. The actuating knob is in particular configured to be displaceable, and a strength of the respective braking or acceleration maneuver is defined as a function of a displacement path of the actuating knob. Alternatively or additionally, the strength is defined as a function of an actuation force of the actuating knob. The further the actuating knob is displaced or the harder the actuating knob is pressed, the stronger the respective braking or acceleration maneuver preferably is. Alternatively, only an actuation of the actuating knob is detected and, if actuation is identified, a braking or acceleration maneuver with a specified strength is carried out, in particular a full braking maneuver as a panic braking operation.

According to an example embodiment of the present invention, it is particularly preferably provided that the assignment of the actuation mode to the respective request is defined as a function of an error state and/or an operating state of the at least one first and/or second actuating device. Taking into account the error state of at least one of the actuating devices creates a particularly advantageously flexible option for using the actuating device. In the event of a malfunction of the first actuating device, the detection of the independent request by the second actuating device implemented in normal operation is suspended, for instance, so that the second actuating device is now used only to identify the braking, acceleration and/or steering request. If the motor vehicle also comprises a further first actuating device, which is used to identify the braking, acceleration and/or steering request and likewise exhibits an error, an actuation mode of the second actuating device is preferably selected such that the request otherwise identified by the further first actuating device is or can also be identified by the second actuating device, provided that the second actuating device allows a sufficient number of degrees of freedom. The second actuating device compensates both a failure of a pedal arrangement, in particular a brake pedal and/or an accelerator pedal, and a steering handle, in particular a steering wheel, for example. In the above-described configuration of the actuating device, for instance, this functions as an actuating lever that is configured to be pivotable or displaceable in at least four directions. On the other hand, if only the pedal arrangement has failed, the second actuating device compensates only its failure, for example to identify an acceleration request and/or a braking request; the actuation modes used for the alternative identification of a steering request are not monitored, however. Based on the aforementioned actuating lever, only a displacement or pivoting of the actuating lever in two of the directions, for example to the front and to the rear, is used instead to determine the request. Displacement or pivoting of the actuating lever in the two other of the directions, for example to the left and to the right, would remain without function, however, and would therefore not trigger a corresponding steering maneuver.

According to a preferred further development of the present invention, it is provided that a strength of the respective braking, acceleration or steering maneuver is defined as a function of the actuation force, a state of at least one component of the motor vehicle, environment information, surroundings information and/or a speed of the motor vehicle.

Such a situation-related setting of the strength of the corresponding maneuver advantageously ensures optimal maneuvering of the motor vehicle. The strength of the maneuver increases with the actuation force, for instance; in particular linearly, progressively, or degressively, preferably in accordance with a common brake pedal characteristic curve. For example, if a failure of a component of the brake system, such as an electronic stability program, is detected, the strength of the braking maneuver is limited to prevent locking of the wheels. If the environment information or surroundings information indicates that there are a large number of other road users in the vicinity of the motor vehicle, for instance, or that the road conditions or weather conditions are unfavorable, for example rain, snow or ice, the strength of all maneuvers is limited in order to maneuver the vehicle safely.

The strength of a steering maneuver and/or an acceleration maneuver is preferably limited as the vehicle speed of the motor vehicle increases in order to maneuver the vehicle safely.

According to an example embodiment of the present invention, it is particularly preferably provided that the respective request is identified only once the actuation duration reaches at least a specified period of time. This advantageously reduces the likelihood of incorrect operation on the part of the driver. For example, the request is identified only once the actuation duration is at least one, in particular two seconds, preferably five seconds.

According to a preferred further development of the present invention, it is provided that the respective request is identified only once a multiple actuation of the actuating device, in particular in a specified period of time, in accordance with the actuation mode has been identified. This advantageously reduces the likelihood of incorrect operation on the part of the driver. For example, the request is identified only once the actuating device has been actuated at least twice, in particular three times, in particular at a respective interval of less than one, in particular two, preferably five seconds.

According to an example embodiment of the represent invention, the motor vehicle according to the present invention includes at least a first and a second actuating device which can be actuated by a driver and is characterized by a control device which is specially designed to carry out the method according to the present invention. This, too, results in the aforementioned advantages. The first actuating device preferably comprises a pedal arrangement and/or steering handle. Alternatively or additionally, the second actuating device comprises two actuating elements disposed on a steering handle of the motor vehicle, in particular paddle shifters or for setting a recuperation, an actuating lever, in particular an automatic selector lever or a gear selector lever, and/or an actuating knob, in particular for actuating a parking brake.

Further preferred features and combinations of features result from the above-described and rest of the disclosure herein. The present invention will be explained in more detail in the following with reference to the figures.

### BRIEF DESCRIPTION OF THE DRAWINGS

FIG. 1 shows a motor vehicle, according to an example embodiment of the present invention.

FIG. 2 shows a method for operating the motor vehicle, according to an example embodiment of the present invention.

### DETAILED DESCRIPTION OF EXAMPLE EMBODIMENTS

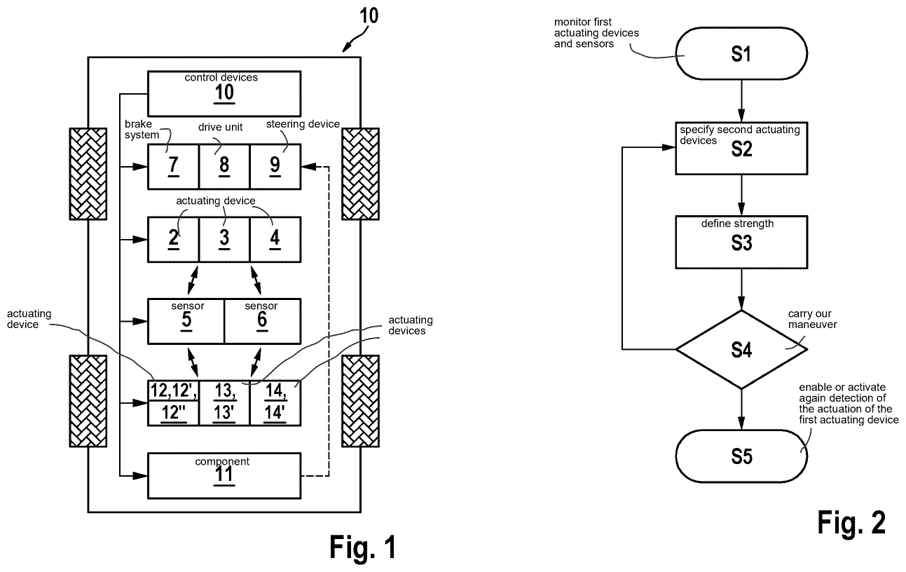

FIG. 1 shows a motor vehicle 1; in this case comprising a first (first primary) actuating device 2, for example configured as a brake pedal, a further first (second primary) actuating device 3, for example configured as an accelerator pedal, and a further first (third primary) actuating device 4, for example configured as a steering handle. The actuating devices 2, 3, 4 are all configured to be actuated by a driver of the motor vehicle 1.

For this purpose, each of the actuating devices 2, 3, 4 here is assigned a first sensor 5 and a second sensor 6 for redundantly detecting actuation of the actuating device 2, 3, 4 as indicated by respective double arrows. For the sake of clarity, only one of the sensors 5, 6 is shown in each case in FIG. 1. A brake system 7, a drive unit 8 and a steering device 9 of the motor vehicle 1 are controlled as a function of a detected actuation of the actuating device 2, 3, 4.

In the present case, therefore, in a normal operation of the motor vehicle 1, when the respective actuating device 2, 3, 4 is actuated, the first actuating device 2 specifies a braking request, the further first actuating device 3 specifies an acceleration request and the further first actuating device 4 specifies a steering request.

The motor vehicle 1 further comprises at least one control device, in particular a plurality of control devices 10, as well as one, in particular a plurality of components 11. The components 11 are in particular each assigned to the brake system 7, the drive unit 8 or the steering device 9 as indicated by a dashed arrow.

The motor vehicle 1 further comprises a second (first secondary) actuating device 12 comprising two actuating elements 12′ disposed on the steering handle, 12″, in particular paddle shifters or for setting a recuperation, a further second (second secondary) actuating device 13 comprising an actuating lever 13′, in particular an automatic selector lever or a gear selector lever, and a further second (third secondary) actuating device 14 comprising an actuating knob 14′, in particular for actuating a parking brake.

The second actuating devices 12, 13, 14 are configured to specify a request in a normal operation that is independent of the braking, acceleration and/or steering request of the actuating device 2, 3, 4, in particular a gear of a transmission of the drive unit 8, a degree of recuperation of the drive unit 8 and/or the actuation of the parking brake of the brake system 7.

The second actuating devices 12, 13, 14 are further configured to alternatively specify a braking, acceleration and/or steering request if a malfunction of one of the first actuating devices 2, 3, 4 and/or the sensors 5, 6 has been detected.

Similarly to the first actuating devices 2, 3, 4, each of the second actuating devices 12, 13, 14 is in particular likewise assigned at least one sensor for detecting its actuation. The actuating devices 12, 13, 14 are preferably also each assigned a first and a second sensor for redundantly detecting their actuation. For the sake of clarity, the assignment of these sensors is indicated by the first sensor 5 and the second sensor 6 and the respective double arrows. Preferably, however, each actuating device 2, 3, 4, 12, 13, 14 has at least one own sensor of its own.

The control device 10 is in particular configured to monitor the first actuating devices 2, 3, 4, the second actuating devices 12, 13, 14, the sensors 5, 6 and/or the components 11 for a malfunction, and to control the brake system 7, the drive unit 8 and the steering device 9 as a function of actuation of the actuating device 2, 3, 4 as indicated by arrows.

An advantageous method for operating the motor vehicle 1 is described in the following with reference to FIG. 2. FIG. 2 shows the method using a flow chart. The method in particular ensures that an advantageous redundancy for detecting the braking, acceleration and/or steering request is created. The method is preferably carried out by the control device 10.

In a step S1, the method begins by monitoring the first actuating devices 2, 3, 4 and the sensors 5, 6 for a malfunction. If a malfunction is identified, the method is continued with a step S2.

In step S2 then, at least one of the second actuating devices 12, 13, 14 is specified, the actuation of which is monitored instead of the actuating device 2, 3, 4 with a malfunction. For this purpose, an actuation duration, actuation force and/or actuation mode of the respective second actuating device 12, 13, 14 is acquired and the braking, acceleration and/or steering request is instead ascertained as a function of this as described above.

If, for example, one of the two actuating devices 2, 3 for detecting a braking request or an acceleration request has failed, a braking or acceleration request is in particular identified as an actuation mode when the two actuating elements 12′, 12″ are actuated simultaneously. If the actuating elements 12′, 12″ can be displaced or pivoted in a first and a second direction, a braking request is identified in particular when the actuating elements 12′, 12″ are actuated simultaneously in the first direction and an acceleration request is identified when they are actuated in the second direction, or an acceleration request is identified when at least one of the actuating elements 12′, 12″ is actuated in the first direction and a braking request is identified when at least one of the actuating elements is actuated in the second direction.

If the actuating elements 12′, 12″ are disposed on the steering handle as a left and a right actuating element, and if the first actuating device 4 for detecting a steering request has failed, for instance, a corresponding steering request in the respective direction is identified as the actuation mode in particular when only the left and right actuating elements 12′, 12″ are actuated.

If the actuating elements 12′, 12″ are disposed on the steering handle as a left and a right actuating element, and if one of the two actuating device 2, 3 for detecting a braking request or an acceleration request has failed for instance, a braking request is identified as the actuation mode in particular when only the left actuating element is actuated and an acceleration request is identified when the right actuating element is actuated.

When using the second actuating device 13 with the actuating lever 13′ that can be displaced or pivoted at least in a first and a second direction, the actuation mode is similarly identified, depending on which of the actuating elements 2, 3, 4 has failed, as a braking request when actuation takes place in the first direction and an acceleration request when actuation takes place in the second direction, or a steering request to the left when actuation takes place in the first direction and a steering request to the right when actuation takes place in the second direction.

If the actuating lever 13′ can be displaced or pivoted in four directions, in particular mutually orthogonal directions, i.e. as is the case with a joystick, a steering request to the left is identified as the actuation mode in particular when actuation takes place to the left (from the perspective of the driver or in relation to the motor vehicle 1), a steering request to the right is identified as the actuation mode in particular when actuation takes place to the right, a braking request is identified as the actuation mode when actuation takes place to the rear, and an acceleration request is identified as the actuation mode when actuation takes place to the front.

When using the second actuating device 14 with the actuating knob 14′, a braking request or an acceleration request is identified as the actuation mode when said knob is actuated.

As described above, the assignment of the actuation mode to the respective request is in particular dependent on the respective error states of at least the first actuating devices 2, 3, 4, particularly preferably also on the error states of the second actuating devices 12, 13, 14.

If, for instance, the steering handle as a whole is in an error state and with it both the first actuating device 4 and the second actuating device 12, the actuating elements 12′, 12″ cannot be used instead to ascertain the steering request. The only option then is to use the second actuating device 13 with the actuating lever 13′. A prioritization is in particular defined here in advance; i.e. the use of which of the actuating devices 12, 13, 14 is preferred.

The respective request is preferably identified only once the actuation duration reaches at least a specified period of time and/or once a multiple actuation of the actuating device 12, 13, 14, in particular in a specified period of time and in particular in accordance with one of the aforementioned actuation modes, has been identified.

In a step S3, the strength of the respective braking maneuver, acceleration maneuver or steering maneuver to be derived from the request is defined. The strength of the maneuver is in particular fixed. Alternatively, the strength is defined as a function of the actuation force, a state of the at least one component 11 of the motor vehicle 1, environment information, surroundings information and/or a speed of the motor vehicle 1. For this purpose, these are first ascertained and assigned to corresponding strength values, for example based on a predefined relationship, in particular using corresponding characteristic curves or lookup tables.

In step S4 then, the respective braking maneuver, acceleration maneuver or steering maneuver is carried out. The actuating device 12, 13, 14 continues to instead be monitored for actuation until it is identified that the respective first actuating device 2, 3, 4 is again functional so the method jumps back to step S2. However, as soon as it is identified in step S4 that the malfunction has been resolved, the method continues with a step S5.

The method then ends with step S5, in which the detection of the actuation of the first actuating device 2, 3, 4 is enabled or activated again, and the alternative detection of the actuation of the second actuating device 12, 13, 14 is suspended or deactivated.

1-15. (canceled)

16. A method for operating a motor vehicle, wherein the motor vehicle includes at least one first actuating device which can be actuated by a driver for specifying a braking request and/or an acceleration request and/or steering request, wherein the motor vehicle includes at least one second actuating device which can be actuated by the driver for specifying a request in a normal operation that is independent of the braking request and/or the acceleration request and/or the steering request, the method comprising the following steps:
monitoring the first actuating device for a malfunction;
based on a malfunction of the first actuating device being identified, ascertaining the braking request and/or the acceleration request and/or the steering request as a function of an actuation duration and/or actuation force and/or actuation mode of the second actuating device; and
carrying out a corresponding braking and/or acceleration and/or steering maneuver as a function of the ascertained braking requested and/or the ascertained acceleration requested and/or the ascertained steering requested.

17. The method according to claim 16, wherein a steering device of the motor vehicle and/or a brake system of the motor vehicle and/or a drive unit of the motor vehicle are controlled as a function of the ascertained braking request and/or the ascertained acceleration request and/or the ascertained steering request.

18. The method according to claim 16, wherein the second actuating device is configured such that at least two different actuation modes for: (i) a braking and an acceleration request and/or (ii) a steering request to the left and to the right, can be detected or are detected.

19. The method according to claim 16, wherein the second actuating device includes two actuating elements including paddle shifters or for setting a recuperation, which are disposed on a steering handle of the motor vehicle.

20. The method according to claim 19, wherein, when both of the two actuating elements are actuated simultaneously, a braking request or acceleration request is identified as the actuation mode.

21. The method according to claim 19, wherein the actuating elements can both be displaced or pivoted in a first direction and in a second direction opposite to the first direction, and: (i) when both of the actuating elements are actuated simultaneously in the first direction a braking request is identified as the actuation mode and when the both of the actuation elements moved in the second direction, an acceleration request is identified as the actuation mode, or (ii) when at least one of the actuating elements is actuated in the first direction an acceleration request is identified as the actuation mode and when at least one of the actuating elements is actuated in the second direction a braking request is identified as the actuation mode.

22. The method according to claim 19, wherein the actuating elements are disposed on the steering handle as a left actuating element and a right actuating element, and: (i) when only the left or only the right actuating element is actuated, a corresponding steering request in a respective direction is identified as the actuation mode, or (ii) when only the left actuating element is actuated, a braking request is identified as the actuation mode and when only the right actuating element is actuated an acceleration request is identified as the actuation mode.

23. The method according to claim 16, wherein the second actuating device includes an actuating lever, including an automatic selector lever or a gear selector lever, which can be displaced or pivoted at least in a first direction and in a second direction opposite to the first direction, and: (i) a braking request is identified as the actuation mode when the actuating lever is actuated in the first direction and an acceleration request is identified as the actuation mode when the actuating lever is actuated in the second direction, or (ii) when the actuating lever is actuated in the first direction, a steering request to the left is identified as the actuation mode, and, when the steering lever is actuated in the second direction, a steering request to the right is identified as the actuation mode.

24. The method according to claim 23, wherein the actuating lever can be displaced or pivoted in at least four mutually orthogonal directions, and when the actuating lever is actuated in one of the four directions, either a braking request, or an acceleration request, or a steering request to the left or a steering request to the right are identified as the actuation mode, so that each of the four directions is assigned its own request, wherein the directions: (i) for a braking and an acceleration request, and (ii) for the steering request to the left and to the right are respectively assigned opposite to one another.

25. The method according to claim 16, wherein the second actuating device includes actuating knob for actuating a parking brake, and when the actuating knob is actuated, a braking request or an acceleration request is identified as the actuation mode.

26. The method according to claim 16, wherein an assignment of the actuation mode to the respective request is defined as a function of an error state and/or an operating state of the at least one first and/or second actuating device.

27. The method according to claim 16, wherein a strength of the braking and/or acceleration and/or steering maneuver is defined as a function of an actuation force and/or a state of at least one component of the motor vehicle and/or environment information, and/or surroundings information and/or a speed of the motor vehicle.

28. The method according to claim 16, wherein the braking request and/or the acceleration request and/or the steering request is identified only once an actuation duration reaches at least a specified period of time.

29. The method according to claim 16, wherein the braking request and/or the acceleration request and/or the steering request is identified only once a multiple actuation of the actuating device in a specified period of time in accordance with the actuation mode has been identified.

30. A motor vehicle, comprising:
at least one first actuating device which can be actuated by a driver for specifying a braking request and/or an acceleration request and/or steering request, and at least one second actuating device which can be actuated by the driver for specifying a request in a normal operation that is independent of the braking request and/or the acceleration request and/or the steering request; and
a control device configured to:
monitor the first actuating device for a malfunction,
based on a malfunction of the first actuating device being identified, ascertain the braking request and/or the acceleration request and/or the steering request as a function of an actuation duration and/or actuation force and/or actuation mode of the second actuating device, and
carry out a corresponding braking and/or acceleration and/or steering maneuver as a function of the ascertained braking requested and/or the ascertained acceleration requested and/or the ascertained steering requested.
